(19) United States
(12) Patent Application Publication
(10) Pub. No.: US 2004/0128319 A1
(43) Pub. Date: Jul. 1, 2004

(54) System and method for automatically finding gaming partners based on pre-established criteria

(75) Inventors: J. Michael Davis, Renton, WA (US); Matthew J. Feldman, Issaquah, WA (US); Bernard John Johansen II, Carlsbad, CA (US)

Correspondence Address: GREENBERG-TRAURIG, 1750 TYSONS BOULEVARD, 12TH FLOOR, MCLEAN, VA, 22102, US

(73) Assignee: Versaly Games, Inc., Issaquah, WA

(21) Appl. No.: 10/637,047

(22) Filed: Aug. 8, 2003

Related U.S. Application Data
(60) Provisional application No. 60/401,800, filed on Aug. 8, 2002.
(60) Provisional application No. 60/401,801, filed on Aug. 8, 2002.

(51) Int. Cl. G06F 155/00

(52) U.S. Cl. 707/104.1; 700/91

(57) ABSTRACT

A system and methods for automatically and selectively matching prospective opponents to facilitate playing a game. The invention takes participant preferences and participant identification information into account in making such matches in an effort to make the game play enjoyable for all participants and to match prospective opponents with a minimum of participant input.

This application is related to, and claims the benefit of, U.S. Provisional Patent Application Serial No. 60/401,801, filed Aug. 8, 2002, the teachings of which are incorporated herein by reference in their entirety. This application is also related to, and claims the benefit of, U.S. Provisional Patent Application Serial No. 60/401,800, filed Aug. 8, 2002, the teachings of which are incorporated herein by reference in their entirety. This application is further related to the U.S. Patent Application entitled “System and Method for Combining Automatic Opponent Matching for Computer Gaming with Chat Room Searchers” filed on even date herewith by the inventors of the present invention, the teachings of which are included herein by reference in their entirety.

### FIELD OF THE INVENTION

The present invention relates to the field of computer gaming and, more specifically, the present invention provides a system and methods for selecting one or more gaming partners to play a game with or against a player.

### BACKGROUND OF THE INVENTION

Computer games have been around for many years, allowing players to play games from those as simple as Pong to advanced flight and combat simulators. While many computer games are intended to be played by a single player, most players find it more exciting to play against a human or computer opponent. Thus, computer game manufacturers have found an ever-increasing market for multiplayer games. Initially, such multiplayer games were played by two or more players on the same computer, game console, or other such gaming device.

As technology has advanced, players need no longer be on the same gaming device, or even in the same room. Some of the first remote multiplayer games used telephone lines and modems to connect two or more gaming devices through a “dedicated” connection between the devices. While dedicated connections did allow for multiplayer games, dedicated connections had the potential to be very expensive, especially when long distance or other telephone charges were applied. Another disadvantage of dedicated connections is that players must always know with whom they are playing, and need to negotiate a playing time and game in advance. It should be noted that variations on the direct connection method persist even with modem internet technology. However, in place of phone numbers, players exchange network identity information, such as Internet Protocol (IP) addresses.

As the Internet has become more widely adopted, several World Wide Web sites were created which allowed players to play multiplayer games against friends or strangers whenever they want and without the costs associated with dedicated connections. These World Wide Web sites are commonly referred to as “game lobbies”. In a game lobby, people access a site devoted to a particular game, such as Starcraft, published by Blizzard Entertainment of Irvine, Calif., or Myth, published by Bungie Studios of Redmond, Wash., or type of game (e.g. http://games.yahoo.com for board and card games). Game lobbies usually have hundreds of people playing individual games simultaneously, with players typically playing a game from start to finish, and playing games with structured starting and ending points.

Game lobbies also frequently implement some organizational structure to allow quick access to games of interest. Given that players frequently like to talk before or after a game, most game lobbies implement their organization as formal parts of a chat room. For example, games.yahoo.com has beginner, intermediate and advanced “sub”-chat rooms for chess, bridge, and the like. Others are less structured, such as http://www.Battle.net, a web site for Starcraft, where players frequently name their games with phrases like “newbies only”. However, both of these methods are largely voluntary. Thus, advanced players can play games in beginner rooms at games.yahoo.com and advanced players can create and “advertise” a game as a “newbies only” game on Battle.net.

In an attempt to make games more fair, some lobbies have begun tracking player information. Such information may be voluntarily submitted by the player, for example, skill level at chess, or the information may be determined by a lobby from a game, such as player rating in Starcraft. Most lobbies implementing such tracking systems allow would-be opponents or teammates to view this information before agreeing to play a game.

While access to player information can be advantageous for other players, lobbies currently implement player information tracking and information display systems in a manner that requires a large display device to manage the information successfully. In addition, the voluntary nature of much of this information makes it inherently unreliable, and many players have come to disregard it. People can lie about their skill level and even their identity because users log into these sites in a manner independent from their primary internet identity or other common identifier.

Game lobbies are not the only method through which players meet for multiplayer games. Another common multiplayer meeting system utilizes real time servers. Real time servers are typically used for games whose beginning and ending points are less structured, such as “repeating one-shot games” and “persistent worlds”. Persistent world games are also known as multi-user dungeons, or MUDs. Examples of these persistent world games include Everquest, produced by Sony Online Entertainment, Inc. of San Diego, Calif.; and Ultima Online, produced by Electronic Arts, Inc. of Redwood City, Calif. These games run constantly, and players frequently have some permanent asset or assets located in the game whether they are currently playing or not. Real time servers supporting these games typically do not allow team member or opponent matching, primarily because opponents and team members may come and go as the game is played without causing the game to cease.

Repeating one-shot games are frequently multiplayer first-person-shooters like Quake, produced by Id Software, Inc., of Texas; Tribes, produced by Sierra Entertainment, Inc. of Bellevue, Wash.; and Half-Life, also produced by Sierra Entertainment, Inc. Some real time servers supporting these games may implement chat rooms as described above, but many simply display a list of games in progress and allow people to drop in and out of the game at will. These games typically involve two teams of people playing a “cops and robbers” or other team-based adversarial style scenario and if occasionally there are more members of one team than the other, the game does not suffer for it. Again, like persistent worlds, the player has little direct choice in who his opponents are. It is possible for players of these games to devise a method similar to the direct connection technique described above, such as connecting to the same server at the same time, to ensure they are playing with people they like, but these game servers typically do not allow for any more advanced teammate or opponent selection techniques.

As with game lobbies, the user interfaces generated by real time game servers supporting repeating one-shot games and persistent worlds are frequently designed for fairly high resolution displays with large display areas. Neither game lobbies nor real time game servers are currently designed to accommodate the increasing number of portable game devices, such as portable digital assistants (PDAs), cellular telephones, and the like. These devices typically provide only limited display areas and displays with relatively limited resolutions.

### SUMMARY OF THE INVENTION

What is therefore needed are systems and methods through which players can meet, select opponents and/or teammates based on voluntary and learned information, control access to games, and otherwise improve their gaming experience. It would be especially advantageous if these systems and methods can be utilized across a wide range of display sizes and display resolutions. Accordingly, the present invention is directed to a system and methods for automatically finding gaming partners that substantially obviates one or more of the problems due to limitations and disadvantages of the related art.

An object of the present invention is to provide a system and method through which game participants can be automatically selected and managed.

Another object of the present invention is to provide a system and methods through which players can more carefully select and manage game participants with whom they are matched.

A further object of the present invention is to provide a system and methods through which game participants can be selected and managed via a devices with a wide range of display sizes and resolutions.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

Multiplayer games are becoming available on a wide variety of devices, including small hand held devices with small display screens. By connecting these devices to the Internet, a device owner can play multiplayer games with strangers or friends. Most methods for finding opponents or teammates in online games require a large display to present the universe of opponents, and these techniques are not well suited for devices with a small display area. The present invention addresses the need to find game participants for multiplayer games on devices with a limited display areas.

The present invention solves the display area problem in two ways. One way is by implementing a state of the art chat room that is structured around a more manageable screen size. The present invention also introduces an automated opponent matching service which eliminates the need for game chat rooms.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a preferred hardware architecture for implementing the present invention, suitable for local and distance-based gaming.

FIG. 2 is a block diagram illustrating an alternative hardware architecture for implementing the present invention, suitable for local gaming.

FIG. 3 is a block diagram illustrating another alternative hardware architecture for implementing the present invention, suitable for server-less local gaming.

FIG. 4 is a flow chart illustrating a preferred opponent matching method.

### DETAILED DESCRIPTION OF THE PREFERRED EMBODIMENT

Reference will now be made in detail to the preferred embodiments of the present invention, examples of which are illustrated in the accompanying drawings.

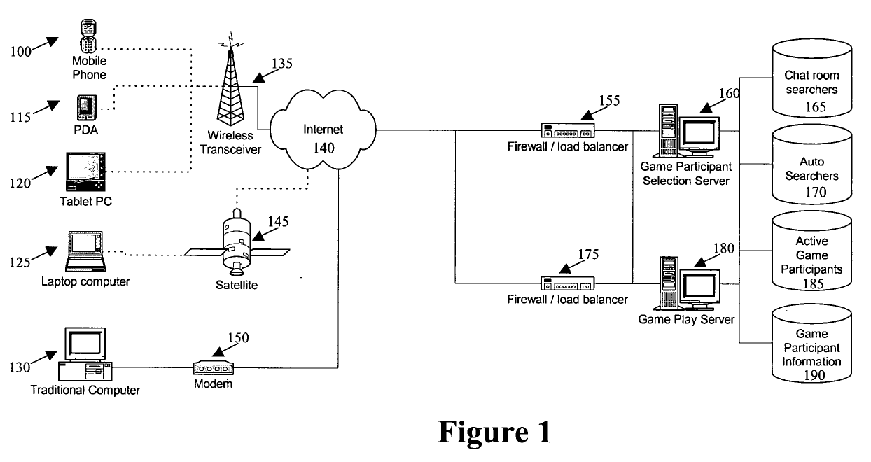

FIG. 1 is a block diagram illustrating a preferred hardware architecture for implementing the present invention which is suitable for both local and distance-based gaming. As FIG. 1 illustrates, a preferred embodiment of the present invention uses two databases, referred to herein as chat room searchers 165 and auto searchers 170, as part of game participant selection server 160.

The present invention preferably maintains game participant information, including game participant preferences, in a database, illustrated as game participant information 190 in FIG. 1. Information preferably tracked in game participant information 190 includes, but is not limited to, Personal Information, Skill Level, Location, Language, Buddy lists, and Blocked lists. Additional information tracked in a preferred embodiment of game participant information 190, including specific field names, is provided below. While specific field names and preferred values for some fields are described below, it should be appreciated by one skilled in the art that field names, preferred values, and the like can be easily changed, and additional fields and/or values substituted therefor, without departing from the spirit or the scope of the invention. Information tracked in game participant information 190 is used, for example, to assist game participant selection server 160 in selecting one or more opponents to participate in a game with a game participant.

When game participant selection server 160 is in what is referred to as a “stable configuration”, chat room searchers 165 and auto searchers 170 may contain one or more partially filled game-tables (defined below) of would-be game participants who collectively are not interested in playing a specific game with each other. This configuration is referred to as “stable” because game participant selection server 160 is awaiting the arrival of one or more game participants who can complete a game-table, thus necessitating further action. Once a game table is filled with opponents that are mutually interested in playing a specific game with each other, that table is preferably removed from auto searches 170 and/or chat room 165 and is transferred to game play server 180.

Most of the game participant matching work occurs when a new game participant joins, or announces his or her availability to, the system and indicates the game or games in which the game participant desires to participate. A small amount of work may also occur when a participant leaves the system. A game participant joins the system by initially connecting to game participant selection server 160, which, according to a preferred embodiment of the present invention, causes the game participant to be added to auto searchers 170. In an alternative embodiment, determination of whether a game participant joining the system is added to auto searches 170, chat room searchers 165, or both databases is determined based on the type of device which the game participant is using. In still another embodiment, such a determination may be based on game participant preferences, with such preferences stored in game participant information 190.

A game participant may connect to the present invention using wireless devices, such as mobile phone 100, PDA 115, tablet PC 120, and laptop computer 125, or the connection may be established via a wired device, such as traditional computer 130. Connectivity between game participant selection server 160 and a wireless device may be provided by wireless transceiver 135, such as, but not limited to, one supporting the Institute of Electrical and Electronics Engineers (IEEE) standards 802.11 b and/or 802.11 g, BlueTooth, cellular digital packet data (CDPD), general packet radio service (GPRS), or other such telecommunications standards; satellite 145; or other wireless means, where such wireless means provides access to Internet 140 or another, preferably high speed, telecommunications network. Connectivity between game participant selection server 160 and Internet 140 may also be provided through a wired means, such as via dial-up or high speed modem 150.

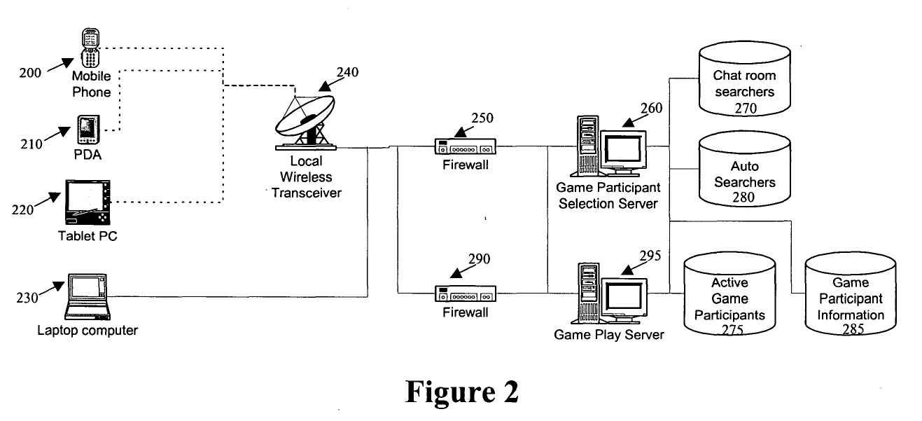

While the system and methods described herein have been specifically designed to allow game participants to connect to the system from anywhere in the world, it should be apparent to one skilled in the art that the present invention can be readily adapted to provide more limited connectivity. By way of example, without intending to limit the present invention, FIG. 2 illustrates an architecture through which the present invention can be implemented to work in a coffee shop, cyber cafe, shopping mall game room, airplane, bus, cruise ship, or other such location. Such an embodiment may be advantageous where a game participant prefers, or is forced, to be in the same physical location as other participants, but would like to use the game participant's own equipment or would like to engage strangers in games.

The embodiment illustrated in FIG. 2 preferably utilizes a wireless communication link between a game participant's game equipment, illustrated as mobile phone 200, PDA 210, and tablet PC 220, and game participant selection server 260 via a local transceiver. However, as illustrated by the connection between laptop computer 230 and Firewall 290, wired communications may also be utilized.

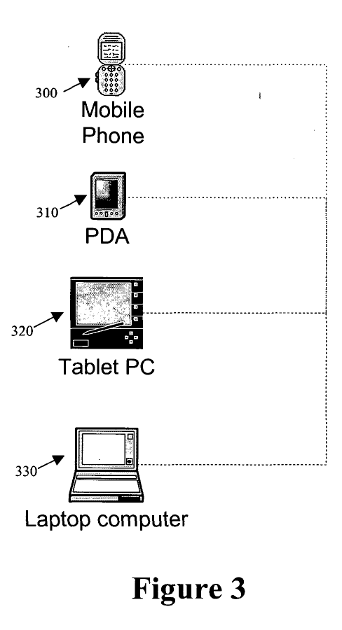

FIGS. 1 and 2 illustrate server-based architectures for deploying the present invention. However, it should be apparent to one skilled in the art that a distributed computing architecture can also be utilized to support the present invention. Distributed computing architectures are typically serverless, with each computer or other device participating therein preferably performing some of the processing necessary to support the system. Such a system is illustrated in FIG. 3. In the illustrated embodiment, mobile phone 300, PDA 310, tablet PC 320, and laptop computer 330 are communicating with each other via a wireless communications protocol, such as BlueTooth or IEEE 802.11b, although wired connectivity can be easily supported. Each device runs special software that enables the device to share the processing overhead necessary to support the present invention without unduly burdening a given device. Such a system allows ad-hoc multiplayer gaming in areas where connectivity to a server or to the Internet is cost prohibitive or otherwise unavailable.

The description included herein generally describes the architecture illustrated in FIG. 1, and specifically focuses on the interaction of auto searchers 170 and game participant selection server 160. A separate patent application, filed by the same inventors on even date with the filing of the present application and entitled “System and Method for Combining Automatic Opponent Matching for Computer Gaming with Chat Room Searchers”, describes the interaction of auto searchers 170 and chat room searchers 165, and the teachings thereof are incorporated herein by reference in their entirety. However, it should be apparent to one skilled in the art that the invention can be adapted to work with alternative architectures, including, but not limited to, those illustrated in FIGS. 2 and 3.

Given the variety of data stored in game participant information 190 and the methods employed by game participant selection server 160, a wide variety of interactions are possible between auto searchers 180, game participant information 190, and game participant selection server 160. A complete description of all the special cases would be exceptionally lengthy, so only the most significant or most frequently encountered cases are described herein. In particular, it is assumed herein that the system starts from a stable state, and the sequence of events which occur as new opponents join the system is described below. While not all special cases are described herein, preferred resolution of such special cases should be understood by one skilled in the art without undue experimentation.

The present invention allows would-be game participants to search for and automatically accept or reject other game participants based on information stored in game participant information 190. For example, without intending to limit the present invention, a player may choose to play with opponents that have either Beginner or Intermediate skill level, live in the same State as he does, speaks any language and doesn't appear on his blocked list. Table 1, below, lists some preferred game participant information 190 fields and preferred possible values within each field.

TABLE 1

| Parameter | Preferred Possible Values |
|---|---|
| Skill Level | Beginner, Intermediate, Expert, Beg-Int, Beg- |
| | Exp, Int-Exp |
| Location | My Postal Code, My City, My State, My |
| | Country, My Time Zone, World |
| Language | English, Chinese, French, German, Japanese, Any |
| Only Buddies | Yes, No |
| Ignore Block | Yes, No |
| List | |

Additionally, each game participant preferably has an entry which records personal information that is used by game participant selection server 150. Table 2, below, lists preferred personal information fields:

TABLE 2

| Parameter | Sample entry for one subscriber |
|---|---|
| Name | Joe Player |
| Address | 12 Elm Street, Anywhere, NY, 10101, USA |
| Spoken | English, Spanish |
| Languages | |
| Buddies | Jane Player, George Gamer, Oscar Opponent |
| Blocked | Sam Card-Shark, Charlie Cheater |

Thus, each game participant brings at least two sets of characteristics to the search for opponents, 1) who they are and 2) who they are looking for. Both of these are preferably defined within the above parameters. Where appropriate the present application will refer to fields defining “who a game participant is” as their identity information, or simply “ID” and “who the game participant is looking for” as their opponent profile, or simply “profile”.

The examples that follow track the system operation for a typical 4 player game. However, it should be apparent to one skilled in the art that the present invention can be readily adapted for play by any number of players without departing from the spirit or the scope of the invention.

Preferred Restrictions and Limitations on the System

When players choose the skill range they wish their opponent to have they must choose a range that includes their own skill level. For example, a player of Beginner skill level can only choose ranges that include Beginners, such as Beginner Only (Beg-Beg), Beginner and Intermediate (Beg-Int), and Beginner to Expert (Beg-Exp).

Location restrictions are preferably based on a game participant's (“my”) locations. Thus it is preferably impossible for a player living in California to choose to play only against opponents living in New York. The only way a Californian can play a New Yorker is to select a profile that includes opponents from “My Country” or the World. Note that doing so still does not guarantee that the Californian will be matched up with a New Yorker, but merely that such a matching may occur.

Two opponent parameters are searched in a manner which, for the purposes of the present invention, is termed “inclusive”. These are Skill Level and Location. For example, without intending to limit the present invention, game participant “A” living in Los Angeles, Calif. may be looking for opponents only in LA (“My City”) while game participant “B”, who also lives in Los Angeles may be looking for opponents anywhere in California (“My State”). B's search will not only look for game participants seeking to play California opponents, but will also include game participants like A who are in California but are doing only city-based searches. Similarly player C of intermediate skill level may be looking only for others of intermediate skill level while player D of intermediate skill level is seeking to play against intermediates or experts. As with the previous example, game participant selection server 160 is able to match players C and D.

It is presently preferred that a game participant who speaks one or more languages can only select from the languages the game participant speaks (as enumerated in the Spoken Languages field of the game participant's personal information), or “Any”. By way of example, a game participant who speaks only English and Spanish can only select from the following choices: English, Spanish, Any. Notice that it is presently preferred that the game participant not be able to choose “English or Spanish”.

Initialization

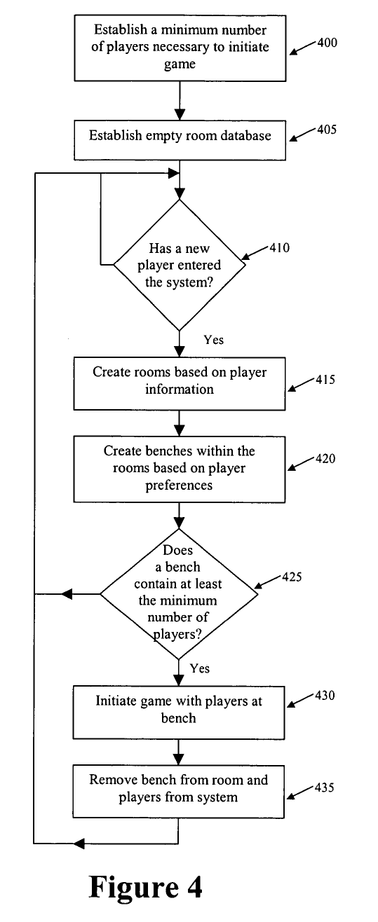

FIG. 4 is a flow chart illustrating a preferred opponent matching method. As illustrated in FIG. 4, the present invention preferably begins with an assumption as to the minimum number of players preferred to play a game (Block 400).

As illustrated by Block 405 of FIG. 4, in the very beginning, the system has zero opponents in it. By default, auto searchers 170 contains tables for the various profile skill level permutations, specifically “Beg-Int”, “Int-Int”, “Int-Exp”, and “Beg-Exp”. A sample data structure for such tables is provided in Table 3.

TABLE 3

Players
Language
Location
Skill

The following is an example of the operation of the present invention with respect to three players, Ai, Bi, and Ci, whose identity information and opponent profiles are shown below in Table 4.

TABLE 4

| | Player Name | | | | | |
|---|---|---|---|---|---|---|
| | Ai | | Bi | | Ci | |
| | ID | Profile | ID | Profile | ID | Profile |
| Language | English | Any | English | Any | English | Any |
| Location | San Fran | My State | San Fran | My State | Los Angeles | My State |
| Skill | Int | Beg-Exp | Int | Beg-Int | Int | Int-Exp |

This example assumes that auto searchers 170 contains an appropriate data structure, but that all fields within that data structure are empty as part of a start-up condition. As illustrated by Block 410 of FIG. 4, ahen player Ai joins the system, game participant selection server 160 creates the following room (Block 415) and Bench (Block 420) entries in auto searchers 170:

TABLE 5
Rooms

| | | | | | | | | |
|---|---|---|---|---|---|---|---|---|
| Language | Any | | Any | | Any | | Any | |
| Location | Calif. | | Calif. | | Calif. | | Calif. | |
| Skill | Beg-Int | | Int—Int | | Int-Exp | | Beg-Exp | |
| Benches | Bench # | Players | Bench # | Players | Bench # | Players | Bench # | Players |
| | Z | Ai | Y | Ai | X | Ai | W | Ai |

As Table 5 illustrates, Ai is added to the list of players, or game participants, in each auto searches 170 table that corresponds to his or her desired opponent skill level. In the vernacular of the present invention, each of these tables is also referred to as a “room”. Each room has one or more “benches” in them as shown in Table 5. These are created, for example, to ensure that a game participant desiring only an intermediate opponent (“Int-Int”, for example) can find any other intermediate opponents in the system. By way of example, without intending to limit the present invention, an intermediate player such as Ai, who is also only looking for an opponent who is of intermediate skill level (“Int-Int”), will be satisfied playing against any intermediate player, regardless of the skill range Ai's opponent desires. In the example above, Ai is an intermediate player looking for players of any skill level, therefore the system places Ai in the Beg-Exp room as well as the Beg-Int, Int-Int and Int-Exp rooms. Intermediate skill players looking to play only other Intermediate skill players will find Ai in the Int-Int room, while Beginners who want to play against players of any skill level (indicated by Beg-Exp) will find Ai on a bench in the Beg-Exp room.

The additions of players Bi and Ci, as defined in Table 4, affect the rooms and benches as shown below in Table 6.

TABLE 6
Rooms

| | | | | | | | | |
|---|---|---|---|---|---|---|---|---|
| Language | Any | | Any | | Any | | Any | |
| Location | Calif | | Calif | | Calif | | Calif | |
| Skill | Beg-Int | | Int—Int | | Int-Exp | | Beg-Exp | |
| Benches | Bench # | Players | Bench # | Players | Bench # | Players | Bench # | Players |
| | Z | Ai, Bi | Y | Ai, Bi, Ci | X | Ai, Ci | W | Ai |

It should be noted that Bi is added to benches Z and Y because Bi has indicated a desire for opponents who are of beginner to intermediate skill (Beg-Int). Similarly, Ci is added to benches Y and X because Ci has indicated a desire for opponents who are of intermediate to expert skill (Int-Exp). Neither Bi nor Ci appear in bench W because, unlike Ai, neither Bi nor Ci has indicated a desire to play against players of any skill.

It should also be noted that for player Bi, the system only searches for matching benches in the “Any_California_Beg-Int” room (i.e. the room containing bench Z) and in the “Any_California_Int-Int” room (i.e. the room containing bench Y). Bi's identification and profile information state that Bi is only interested in playing with opponents from within his state, which allows the system to restrict its searches with respect to Bi to these rooms. A similar situation exists for player Ci in the rooms where he appears.

Standard Player Match:

If the two players listed below in Table 7 are added to the room structure as set forth in Table 6, the result will look similar to Table 8.

TABLE 7

| | Player Name | | | |
|---|---|---|---|---|
| | Joe | | Zi | |
| | ID | Profile | ID | Profile |
| Language | English | Any | English | Any |
| Location | New York | My State | Los Angeles | My State |
| Skill | Int | Beg-Exp | Int | Int |

TABLE 8
Virtual Rooms

| | | | | | | | | | | |
|---|---|---|---|---|---|---|---|---|---|---|
| Language | Any | | Any | | Any | | Any | | Any | |
| Location | Calif | | Calif | | Calif | | Calif | | New York | |
| Skill | Beg-Int | | Int—Int | | Int-Exp | | Beg-Exp | | Beg-Exp | |
| Benches | Bench # | Players | Bench # | Players | Bench # | Players | Bench # | Players | Bench # | Players |
| | Z | Ai, Bi | Y | Ai, Bi, Ci, Zi | X | Ai, Ci | W | Ai | ZZ | Joe |

As Tables 7 and 8 show, when player Joe from New York is added to a room structure such as that shown in Table 6, where that player also desires only opponents in “my state,” at least one new room will preferably be added to accommodate the player. This is necessary as the “my state” for a player from New York will not be “California” and so will not match any of the players in the rooms shown in Table 6.

The addition of Zi to the room structure of Table 6 also gives bench Y four players. As illustrated by Block 430 of FIG. 4, in a game in which four is the number of players preferred to start the game, bench Y is then removed from auto searchers 170 by game participant selection server 160 and handed over to game play server 180, where it is added to active game participants 185. Game play server 180 then handles the details of playing the game. The repetitive, or “duplicate”, copies of players Ai, Bi, and Ci are removed from various remaining benches (Block 435 of FIG. 4). After this removal is complete, the room structure looks similar to that illustrated in Table 9, below.

TABLE 9
Virtual Rooms

| | | |
|---|---|---|
| Language | Any | |
| Location | New York | |
| Skill | Beg-Exp | |
| Benches | Bench # | Players |
| | ZZ | Joe |

To more easily describe the function of the present invention, Joe is ignored in subsequent examples.

Match Across Skill Levels:

The preceding example ended up matching several players of intermediate skill level despite the fact that many of the players would have been happy to play people of different skill levels.

TABLE 10

| Player Name | |
|---|---|
| Db | Ee |

| | ID | Profile | ID | Profile |
|---|---|---|---|---|
| Language | English | Any | English | Any |
| Location | San Fran | My State | San Fran | My State |
| Skill | Beg | Beg-Exp | Exp | Beg-Exp |

Adding the players described in Table 10, above, to the room structure of Table 6 yields a room structure similar to that of Table 11, below.

TABLE 11
Virtual Rooms

| | | | | | | | | | | | | |
|---|---|---|---|---|---|---|---|---|---|---|---|---|
| Language | Any | | Any | | Any | | Any | | Any | | Any | |
| Location | Calif | | Calif | | Calif | | Calif | | Calif | | Calif | |
| Skill | Beg-Int | | Int—Int | | Int-Exp | | Beg-Exp | | Beg—Beg | | Exp—Exp | |
| Benches | Bench | | Bench | | Bench | | Bench | | Bench | | Bench | |
| | # | Players | # | Players | # | Players | # | Players | # | Players | # | Players |
| | Z | Ai, Bi, | Y | Ai, Bi, | X | Ai, Ci, | W | Ai, Db, | V | Db | U | Ee |
| | | Db | | Ci | | Ee | | Ee | | | | |

Adding player Ze, an expert player who is looking for opponents of intermediate to expert skill level as described in Table 12, results in a match as shown below in Table 13.

TABLE 12

Player Name
Ze

| | ID | Profile |
|---|---|---|
| Language | English | Any |
| Location | San Fran | My State |
| Skill | Exp | Int-Exp |

TABLE 13
Virtual Rooms

| | | | | | | | | | | | | |
|---|---|---|---|---|---|---|---|---|---|---|---|---|
| Language | Any | | Any | | Any | | Any | | Any | | Any | |
| Location | Calif | | Calif | | Calif | | Calif | | Calif | | Calif | |
| Skill | Beg-Int | | Int—Int | | Int-Exp | | Beg-Exp | | Beg—Beg | | Exp—Exp | |
| Benches | Bench # | Players | Bench # | Players | Bench # | Players | Bench # | Players | Bench # | Players | Bench # | Players |
| | Z | Ai, Bi, | Y | Ai, Bi, | X | Ai, Ci, | W | Ai, Db, | V | Db | U | Ee, Ze |
| | | Db | | Ci | | Ee, Ze | | Ee | | | | |

Notice that bench X contains four players of different skill levels (intermediates and experts) and that two of the players, Ai and Ee, would be content to play with opponents of any skill level. If four players were necessary or the minimum number necessary to play the given game, bench X would be handed off from game participant selection server 160 to game play server 180 as described above.

Saturated Example

The case of a fully saturated data structure is examined next. Ignoring all other preferences except skill, location, and language, it is possible to have as many as nine people in a room structure without satisfying the minimum player requirements in a four player game. An example of player definitions creating such a saturated data structure is shown below in Table 14.

TABLE 14

| | Player Name | | | | | |
|---|---|---|---|---|---|---|
| | Ab | | Bb | | Cb | |
| | ID | Profile | ID | Profile | ID | Profile |
| Language | English | Any | English | Any | English | Any |
| Location | San Fran | My State | San Fran | My State | Los Angeles | My State |
| Skill | Beg | Beg—Beg | Beg | Beg-Int | Beg | Beg-Exp |
| | Player Name | | | | | |
| | Di | | Ei | | Fi | |
| | ID | Profile | ID | Profile | ID | Profile |
| Language | English | Any | English | Any | English | Any |
| Location | San Fran | My State | San Fran | My State | Los Angeles | My State |
| Skill | Int | Beg-Int | Int | Int—Int | Int | Int-Exp |
| | Player Name | | | | | |
| | Ge | | He | | Ie | |
| | ID | Profile | ID | Profile | ID | Profile |
| Language | English | Any | English | Any | English | Any |
| Location | San Fran | My State | San Fran | My State | Los Angeles | My State |
| Skill | Exp | Beg-Exp | Exp | Int-Exp | Exp | Exp—Exp |

The resulting room structure resembles that shown in Table 15, below.

TABLE 15
Virtual Rooms

| | | | | | | | | | | | | |
|---|---|---|---|---|---|---|---|---|---|---|---|---|
| Language | Any | | Any | | Any | | Any | | Any | | Any | |
| Location | Calif | | Calif | | Calif | | Calif | | Calif | | Calif | |
| Skill | Beg—Beg | | Beg-Int | | Beg-Exp | | Int—Int | | Int-Exp | | Exp—Exp | |
| Benches | Bench # | Players | Bench # | Players | Bench # | Players | Bench # | Players | Bench # | Players | Bench # | Players |
| | Z | Ab, Bb, Cb | Y | Bb, Cb, Di | X | Cb, Ge | W | Di, Ei, Fi | V | Fi, Ge, He | U | Ge, He, Ie |

It should be apparent to one skilled in the art that the addition of any player to the room structure of Table 15 will at least result in a match with that own player's skill level (eg, a beginner will at least match in the Beg-Beg room). By way of example, without intending to limit the present invention, the addition of a player as described in Table 16 results in a room structure similar to that shown in Table 17.

TABLE 16

Player Name
Ze

| | ID | Profile |
|---|---|---|
| Language | English | Any |
| Location | San Fran | My State |
| Skill | Exp | Int-Exp |

TABLE 17
Virtual Rooms

| | | | | | | | | | | | | |
|---|---|---|---|---|---|---|---|---|---|---|---|---|
| Language | Any | | Any | | Any | | Any | | Any | | Any | |
| Location | Calif | | Calif | | Calif | | Calif | | Calif | | Calif | |
| Skill | Beg—Beg | | Beg-Int | | Beg-Exp | | Int—Int | | Int-Exp | | Exp—Exp | |
| Benches | Bench # | Players | Bench # | Players | Bench # | Players | Bench # | Players | Bench # | Players | Bench # | Players |
| | Z | Ab, Bb, | Y | Bb, Cb, | X | Cb, Ge | W | Di, Ei, Fi | V | Fi, Ge, He, Ze | U | Ge, He, Ie, Ze |
| | | Cb | | Di | | | | | | | | |

As shown in Table 17, benches V and U make a complete 4 player game. In a preferred embodiment, situations such as that shown in Table 17, where multiple benches simultaneously would result in the initiation of a game (“playable benches”), are handled by game participant selection server 160 selecting from among the playable benches the bench which has been in existence the longest. Thus, in the room structure shown in Table 17, if Fi has been waiting longer than le, bench V would be chosen. While such a resolution is preferred, as it typically results in the shortest wait times between joining game participant selection server 160 and the initiation of a game, alternative resolutions should be obvious to one skilled in the art.

Blocked List Example

As described above, a preferred embodiment of the present invention allows game participants to create lists of “buddies”, or preferred opponents, as well as lists of “blocked” opponents. When a game participant chooses to block an opponent, that opponent can never appear in a game with the game participant. The following example shows how a game participant's “blocked” list affects room structures. For the purposes of this example, the players described in Table 18 are assumed to have joined game participant selection server 160.

TABLE 18

| | Player Name | | | | | | | |
|---|---|---|---|---|---|---|---|---|
| | Ai | | Bi | | Ci | | Db | |
| | ID | Profile | ID | Profile | ID | Profile | ID | Profile |
| Language | English | Any | English | Any | English | Any | English | Any |
| Location | San Fran | California | San Fran | California | San Fran | California | Los Angeles | California |
| Skill | Int | Beg-Exp | Int | Beg-Int | Int | Int-Exp | Beg | Beg-Exp |

The room structure that would therefore result would look similar to that shown in Table 19.

TABLE 19
Virtual Rooms

| | | | | | | | | | | |
|---|---|---|---|---|---|---|---|---|---|---|
| Language | Any | | Any | | Any | | Any | | Any | |
| Location | Calif | | Calif | | Calif | | Calif | | Calif | |
| Skill | Beg—Beg | | Beg-Int | | Int—Int | | Beg-Exp | | Int-Exp | |
| Benches | Bench # | Players | Bench # | Players | Bench # | Players | Bench # | Players | Bench # | Players |
| | Z | Db | Y | Ai, Bi, Db | X | Ai, Bi, Ci | W | Ai, Db | V | Ai, Ci |

Players described in Table 20 will be individually added to the room structure of Table 19 to illustrate how the room structure changes.

TABLE 20

| Player Name | |
|---|---|
| Eb | Fi |

| | ID | Profile | ID | Profile |
|---|---|---|---|---|
| Block | Bi | | Ai, Bi | |
| Language | English | Any | English | Any |
| Location | San Fran | California | San Fran | California |
| Skill | Beg | Beg-Int | Int | Beg-Int |

Under normal circumstances Eb would be able to join bench Y, but because Eb will not play with Bi, Eb cannot join bench Y. Game participant selection server 160 therefore creates a new bench within the Any₁₃California_Beg-Int room with attributes similar to those of bench Y, but without the players on Eb's block list (in this case, Bi) and seats Eb in the new bench. The resulting room structure is shown in Table 21.

TABLE 21
Virtual Rooms

| | | | | | | | | | | |
|---|---|---|---|---|---|---|---|---|---|---|
| Language | Any | | Any | | Any | | Any | | Any | |
| Location | Calif | | Calif | | Calif | | Calif | | Calif | |
| Skill | Beg—Beg | | Beg-Int | | Int—Int | | Beg-Exp | | Int-Exp | |
| Benches | Bench # | Players | Bench # | Players | Bench # | Players | Bench # | Players | Bench # | Players |
| | Z | Db | Y | Ai, Bi, Db | X | Ai, Bi, Ci | W | Ai, Db | V | Ai, Ci |
| | | | U | Ai, Db, Eb | | | | | | |

Adding Fi to Table 21's room structure results in the room structure shown in Table 22.

TABLE 22
Virtual Rooms

| | | | | | | | | | | |
|---|---|---|---|---|---|---|---|---|---|---|
| Language | Any | | Any | | Any | | Any | | Any | |
| Location | Calif | | Calif | | Calif | | Calif | | Calif | |
| Skill | Beg—Beg | | Beg-Int | | Int—Int | | Beg-Exp | | Int-Exp | |
| Benches | Bench # | Players | Bench # | Players | Bench # | Players | Bench # | Players | Bench # | Players |
| | Z | Db | Y | Ai, Bi, Db | X | Ai, Bi, Ci | W | Ai, Db | V | Ai, Ci |
| | | | U | Ai, Db, Eb | R | Ci, Fi | | | | |
| | | | T | Db, Fi | | | | | | |
| | | | S | Db, Eb, Fi | | | | | | |

Similar to player Eb, player Fi could sit in bench Y but for Fi's refusal to play with Ai or Bi. Game participant server 160 therefore makes a copy of bench Y, removes Ai and Bi, and seats Fi, resulting in bench T. In examining Fi's impact on room U, it should be apparent that Fi could sit in bench U, but for Fi's refusal to play with Ai. Thus, game participant server 160 creates bench S, which is a copy of bench U with Ai removed. A similar process applied to bench X results in the creation of bench R. Mathematically, benches T and S are redundant, but, because it causes game participant selection server 160 no difficulty to keep the separate benches, and because the overhead necessary to analyze and remove ex ante the repetitive benches typically outweighs any benefit to removing them ex post, it is presently preferred to keep the separate benches. Instead, the duplicate benches may be removed during a periodic clean-up for duplicated players and unnecessary benches.

As described above, one reason duplicate benches do not tend to adversely impact the performance of the present invention is that, as shown in the previous example, the system knew from players' Eb and Fi's profile and identification information to only search for opponents in the Any_California₁₃Beg-Int and Any_California_Int-Int rooms. When adding player Fi, for example, the system only needed to examine benches Y, U and X, because only these benches were in rooms compatible with player Fi's identification and profile information. The limited set of benches searched as a result of such intelligence typically provides sufficient efficiency such that any gains realized by cleaning up duplicate benches would be nominal.

Location Matching

Conceptually, location matching and ‘skill based’ matching as described above are both what are termed ‘inclusive’ matches, because game participant selection server 160 can infer information about the search criteria and use that inference in finding a match. By way of example, in the case of location matching a game participant from LA who is looking to play against someone from California, that game participant can be matched up with a game participant from San Francisco looking to play anyone in the USA.

Similar to the skill based matching examples above, the examples below will assume a single skill range, rather than a single location. It should be apparent to one skilled in the art that the techniques taught herein for skill based matching and location matching can then be readily combined to provide even more advanced matching functionality.

Two features are particularly noteworthy in the location matching algorithm. One is the aforementioned inclusiveness. The other is the database search method employed in location matching. Unlike conventional location comparison methods, the method employed in the present invention does not require an extensive database of cities, states, countries, or the like. Instead, the comparison methods only need location information for all the game participants in the search database. Game participant selection server 160 can build a necessary location information hierarchy from such information which is sufficient for the purposes of the present invention. While a preferred embodiment of the system will inherently maintain an extensive database of zip codes, cities, states, and countries as part of its subscriber database, it is not intended that this information be used in performing location matching. Although such data may be used for such purposes, the location information hierarchy creation method described below is preferred as it is expected to be significantly faster than comparisons against a subscriber database or other similar database.

It should be noted that it is presently preferred that a location search feature supported by the present invention, referred to as “My TimeZone”, be exempt from the inclusive location search. Thus, two players from California, one looking to play only Californians and one looking to play anyone in the Pacific Time Zone will not find each other, despite the fact that California is completely contained within the Pacific Time Zone. However, it should be apparent to one skilled in the art that an inclusive time zone search could be substituted therefor without departing from the spirit or the scope of the invention.

A preferred embodiment of the present invention tracks location information down to the postal code (e.g. Zip+4) level. However, for the purposes of the following example, without intending to limit the present invention, location information is tracked down to the city level to simplify the explanation thereof. Similarly, since skill and language do not impact purely location-based searches, those information fields are ignored as part of this description. However, given the skill based search description set forth above, it should be apparent to one skilled in the art how a location search could be expanded to take skill and language into account.

Initialization

For the purposes of this example, it is assumed that no game participants have joined game participant selection server 160. If game participants LACity and NYCity, described in Table 23, join game participant selection server 160, a room structure similar to that shown in Table 24 will result.

TABLE 23

| | Player Name | | | | | |
|---|---|---|---|---|---|---|
| | LAcity | | NYcity | | SeaState | |
| | ID | Profile | ID | Profile | ID | Profile |
| Location | | My City | | My | | My |
| | | | | City | | State |
| City | Los | | New | | Seattle | |
| | Angeles | | York | | | |
| State | California | | New | | Washington | |
| | | | York | | | |
| Country | USA | | USA | | USA | |

TABLE 24
Virtual Rooms

| | | | | |
|---|---|---|---|---|
| Location | Los Angeles | | New York (city) | |
| Benches | Bench # | Players | Bench # | Players |
| | Z | LAcity | Y | NYcity |

The process by which the room structure of Table 24 is created is straightforward. The location resolution upon which rooms are created is preferably determined by the lowest level specified by the game participants who have joined game participant selection server 160. Thus, when LAcity and NYcity join game participation selection server 160, a room structure based around the lowest level (cities in this example) is created. Adding someone who is searching for something other than the lowest level, such as game participant SeaState from Table 23, preferably results in a different room structure, as shown in Table 25.

TABLE 25
Virtual Rooms

| Location | Los Angeles | | New York (city) | | Washington (state) | | Seattle | |
|---|---|---|---|---|---|---|---|---|
| Benches | Bench # | Players | Bench # | Players | Bench # | Players | Bench # | Players |
| | Z | LAcity | Y | NYcity | X | SeaState | W | SeaState |

In Table 25, game participant SeaState is added to a room for “MyState” (Washington) and a room for his city (Seattle). Note that the information that Seattle is in Washington is gathered from the game participant when the game participant first creates an account with the system. In a preferred embodiment, such information is stored as part of the game participant's ID information.

City Match

If another game participant from New York City (NYC) who is also looking to play against someone from NYC, such as game participant NYC2 described in Table 26, is added to the room structure of Table 25, a room structure similar to that of Table 27 will result.

TABLE 26

| Player Name | NYC2 | |
|---|---|---|
| | ID | Profile |
| Location | | My City |
| City | New York (city) | |
| State | New York | |
| Country | USA | |

TABLE 27
Virtual Rooms

| Location | Los Angeles | | New York (city) | | Washington (state) | | Seattle | |
|---|---|---|---|---|---|---|---|---|
| Benches | Bench # | Players | Bench # | Players | Bench # | Players | Bench # | Players |
| | Z | LAcity | Y | NYcity, NYC2 | X | SeaState | W | SeaState |

As Table 27 shows, NYcity and NYC2 both end up in bench Y. If this were a two player game, NYcity and NYC2 would be matched up and the bench would be handed off to game play server 180.

State Match

If a player from Washington State who does not live in Seattle, but who is looking to play anyone in Washington State, such as Wash2, described in Table 28, below, is added to the room structure shown in Table 25, a room structure similar to Table 29 will result.

TABLE 28

| Player Name | Wash2 | |
|---|---|---|
| | ID | Profile |
| Location | | My State |
| City | Tacoma | |
| State | Washington | |
| Country | USA | |

TABLE 29
Virtual Rooms

| Location | Los Angeles | | New York (city) | | Washington (state) | | Tacoma | | Seattle | |
|---|---|---|---|---|---|---|---|---|---|---|
| Benches | Bench # | Players | Bench # | Players | Bench # | Players | Bench # | Players | Bench # | Players |
| | Z | LAcity | Y | NYcity | X | SeaState, | W | Wash2 | V | SeaState |
| | | | | | | Wash2 | | | | |

Note that a room with bench W is preferably created for Wash2 just in case someone from Tacoma looking for a game against someone else from Tacoma comes online. Notice that SeaState and Wash2 are appropriately matched in bench X.

City-Plus Match

In this example, another game participant from Los Angeles, LA2, who is described in Table 30, joins game participant selection server 160 with a room structure as described in Table 25.

TABLE 30

| Player Name | LA2 | |
|---|---|---|
| | ID | Profile |
| Location | | World |
| City | Los Angeles | |
| State | California | |
| Country | USA | |

Adding LA2 to the room structure of Table 25 results in a room structure similar to that of Table 31.

TABLE 31
Virtual Rooms

| Location | Los Angeles | | New York (city) | | Washington (state) | | World | | USA | | Seattle | | California | |
|---|---|---|---|---|---|---|---|---|---|---|---|---|---|---|
| Benches | Bench # | Players | Bench # | Players | Bench # | Players | Bench # | Players | Bench # | Players | Bench # | Players | Bench # | Players |
| | Z | LAcity, | Y | NYcity | X | SeaState | W | LA2 | V | LA2 | U | SeaState | T | LA2 |
| | | LA2 | | | | | | | | | | | | |

In a preferred embodiment, the need for new room creation is evaluated from the broadest category (in this case, World) down to the narrowest category necessary (in this case, City). Note that this results in the creation of a total of three additional rooms (four total) to accommodate LA2, including rooms for World (bench W), Country (bench V), State (bench T) and City (bench Z). A room for the city in question (Los Angeles) already existed and a player match occurs there. Again, if this were a two player game, bench Z would be passed off to game play server 180, and the room structure would be cleaned to remove references to LAcity and LA2.

As the previous example illustrates, some matches may benefit from room creation evaluation from the broadest category to the narrowest. Other searches may benefit from room creation evaluation from the narrowest category to the broadest. Still others may benefit from simultaneous evaluation from the category specified in a player's identification or profile information. The present invention will preferably support a system administrator or other control authority selecting a preferred evaluation methodology. Such a preferred evaluation methodology may, for example, be determined based on the relative frequency with which broad and narrow categories are selected by game participants, among other factors.

State-Plus Match

A state-plus match is similar to a city-plus match. If someone from Washington state who resembles the game participant described in Table 32 joins game participant selection server 160 while game participant selection server 160 has a room structure similar to Table 25, a room structure similar to Table 33 will result.

TABLE 32

| Player Name | Wash3 | |
|---|---|---|
| | ID | Profile |
| Location | | World |
| City | Tacoma | |
| State | Washington | |
| Country | USA | |

TABLE 33
Virtual Rooms

| Location | Los Angeles | | New York (city) | | Washington (state) | | World | | USA | | Seattle | | Tacoma | |
|---|---|---|---|---|---|---|---|---|---|---|---|---|---|---|
| Benches | Bench # | Players | Bench # | Players | Bench # | Players | Bench # | Players | Bench # | Players | Bench # | Players | Bench # | Players |
| | Z | LAcity | Y | NYcity | X | SeaState, | W | Wash3 | V | Wash3 | U | SeaState | T | Wash3 |
| | | | | | | Wash3 | | | | | | | | |

Here again, three rooms are created for a player searching at the world level, World (with bench W), Country (with bench V), and City (with bench T). Note also that the system did find a match in State (with bench X). It should be noted that had postal code been the lowest resolution supported by the present invention, as opposed to the city resolution limit imposed in this set of examples, the addition of a player at the world level would have also resulted in the creation of a postal code room and bench for that player.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

We claim as our invention:

1. An opponent matching system for matching prospective game participants, and thus facilitating playing a game, comprising:
a game definition, wherein the game definition includes a minimum number of players necessary to initiate a game;
a plurality of game participant devices, wherein each of the plurality of game participant devices is operated by a prospective game participant;
at least one game participant information database, wherein the at least one game participant information database contains information about each of the prospective game participants, including game participant skill level;
at least one auto searchers database, wherein the at least one auto searchers database contains at least one game table for each of the game participant skill levels defined in the at least one game participant information database;
at least one game participant selection server, wherein the at least one game participant selection server evaluates a prospective game participant, wherein the at least one game participant selection server assigns the prospective game participant to a prospective game based on the results of the evaluation, and wherein the at least one game participant selection server initiates a game when the number of prospective game participants is equal to or greater than the minimum number of players specified in the game definition; and,
a communications means, for coupling the plurality of game participant devices to the at least one game participant selection server.

2. The opponent matching system of claim 1, wherein the plurality of game participant devices includes at least one wireless device.

3. The opponent matching system of claim 2, wherein the at least one wireless device is a cellular telephone.

4. The opponent matching system of claim 2, wherein the at least one wireless device is a personal desktop assistant.

5. The opponent matching system of claim 1, wherein the at least one game participant selection server evaluates a prospective game participant as the prospective game participant joins the system, based on information in the at least one game participant information database about the prospective game participant.

6. A method for selectively matching a plurality of prospective opponents in a game to facilitate game play, comprising:
establishing a minimum number of players necessary to initiate a game;
collecting information about each of the plurality of prospective opponents;
building at least one room based on the information collected about each of the plurality of opponents;
establishing at least one bench within the at least one room based on the information collected about each of the plurality of opponents;
assigning prospective opponents to at least one bench as the prospective opponents announce their availability;
initiating a game among the prospective opponents assigned to a bench when the number of prospective opponents assigned to the bench meets or exceeds the established minimum number of players necessary to initiate the game;
removing the bench for which the game was initiated from the room in which the bench was established; and,
removing the players assigned to the bench for which the game was initiated from any other benches to which the players had been assigned.

7. The opponent matching method of claim 6, wherein the information collected about each of the plurality of prospective opponents includes at least the prospective opponent name and skill level.

8. The opponent matching method of claim 7, wherein the at least one room is built based on the set of prospective opponent skill levels in the information collected about each of the plurality of prospective opponents.

9. The opponent matching method of claim 6, wherein the information collected about each of the plurality of prospective opponents includes at least one opponent skill level against which a prospective opponent desires to be matched.

10. The opponent matching method of claim 9, wherein prospective opponents are assigned to the at least one bench based on the desired opponent skill level preference.

11. The opponent matching method of claim 6, wherein the information about each of the plurality of prospective opponents includes at least one language spoken by each opponent.

12. The opponent matching method of claim 11, wherein the at least one room is built based on the set of languages spoken by the plurality of prospective opponents.

13. The opponent matching method of claim 6, wherein the information about each of the plurality of prospective opponents includes a location for each prospective opponent.

14. The opponent matching method of claim 13, wherein the at least one room is built based on the set of prospective opponent locations.

15. The opponent matching method of claim 6, wherein the information about each of the plurality of prospective opponents includes at least location for opponents against whom the prospective opponents desires to be matched.

16. The opponent matching method of claim 15, wherein prospective opponents are assigned to the at least one bench based on desired opponent locations.

17. The opponent matching method of claim 6, wherein the information about each of the plurality of prospective opponents includes, for each prospective opponent, a list of opponents to be blocked from games containing the prospective opponent.

18. The opponent matching method of claim 17, wherein the benches within the at least one room are established based on the prospective opponent block lists.
